(19) United States
(12) Patent Application Publication
(10) Pub. No.: US 2023/0157329 A1
(43) Pub. Date: May 25, 2023

(54) PROCESS FOR ROASTING PLANT MATERIAL WITH OIL

(71) Applicant: SOCIETE DES PRODUITS NESTLE S.A., Vevey (CH)

(72) Inventors: MEERA BHAGAT, Dublin, OH (US); DAVID KOMAREK, Dublin, OH (US); ROHIT UPADHYAY, St. Louis, MO (US)

(21) Appl. No.: 17/995,126

(22) PCT Filed: Mar. 29, 2021
(86) PCT No.: PCT/EP2021/058160

§ 371 Date: Sep. 30, 2022

(30) Foreign Application Priority Data
Apr. 4, 2020 (IN) 202011015003
Jul. 2, 2020 (EP) 20183827.3

(51) Int. Cl. A23L 5/10; A23L 33/115

(52) U.S. Cl. CPC A23L 5/11; A23L 33/115

(57) ABSTRACT

The present invention relates to a process for the production of a roasted plant material with oil. The oil used for roasting the plant material comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

The present invention relates to a process for the production of a roasted plant material with oil. The oil used for roasting the plant material comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

It is already known to have roasted plant material. There are two types of industrially roasting technologies. Most time the roasting is done as dry roasting using no oil. In case oil is used for roasting the plant material is roasted in palm oil due its low cost, ease of availability and high oxidative stability. Consumers are increasingly becoming sensitive to palm oil or palm fat concerns. Many of them perceive palm fat as not healthy due to high amounts of saturated fatty acids (SFA) and many others perceive it as not environmentally sustainable as a lot of news mention that the rain forest is destroyed to grow palm trees.

Therefore in order to provide nutritional benefits, reduction of total fat and/or SFA content in the product is of considerable importance. It is hence essential to explore other vegetable oils for roasting plant material which are not only economical to produce and easy to handle but are also stable for frying purposes. It should make roasted plant material healthier without compromising on the sensory attributes, and overall quality of the product. In addition it should also have lower values of process contaminants formed during refining of oils, i.e. glycidyl fatty acid esters (GE) < 1 ppm (preferably < 0.5 ppm) and 3-MCPD < 3 ppm

### SUMMARY OF THE INVENTION

The object of the present invention is to improve the state of the art and to provide an improved or at least an alternative solution to overcome at least some of the inconveniences described above. The object of the present invention is achieved by the subject matter of the independent claims. The dependent claims further develop the idea of the present invention.

Particularly, the object of the present invention is to provide a process for the production of roasted plant material with a healthier perceived oil having good oxidation stability, low amounts of glycidyl fatty acid esters (< 1 ppm, preferably < 0.5 ppm) and 3-MCPD (<3 ppm), good sensory attributes e.g. having a fried sensory note, and a shelf life of at least 9 months of the product.

Accordingly, the present invention provides in a first aspect a process for the production of a roasted plant material comprising plant material and oil, the process comprising the steps of:
a) Mixing the plant material and the oil;
b) Roasting the mix from step a) between a temperature range of 110-190° C. for 2 to 180 min;
c) Cooling;
d) Optional Milling;
wherein the oil comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

In a second aspect the invention relates to a roasted plant material comprising plant material and oil, wherein the roasted plant material has an amount of oleic acid of at least 2 wt% (by weight of the total composition).

It has been surprisingly found by the inventors that by using an oil for roasting the plant material, wherein the oil comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat), a healthier perceived oil having good oxidation stability, low amounts of glycidyl fatty acid esters (< 1 ppm), low amounts of 3-MCPD (<3 ppm), as well as good sensory attributes e.g. having a fried sensory note, and a shelf-life of at least 9 months of the product can be achieved. In addition as the oil is liquid at room temperature (20° C.) and therefore an easier dosing within the process is achieved compared to a solid palm fat, which needs to be melted first.

### DETAILED DESCRIPTION OF THE INVENTION

In a first aspect the present invention pertains to a process for the production of a roasted plant material comprising plant material and oil, the process comprising the steps of:
a) Mixing the plant material and the oil;
b) Roasting the mix from step a) between a temperature range of 110-190° C. for 2 to 180 min;
c) Cooling;
d) Optionally milling;
wherein the oil comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

In a first aspect the present invention pertains to a process for the production of a roasted plant material comprising plant material and oil, the process comprising the steps of:
a) Mixing the plant material and the oil;
b) Roasting the mix from step a) between a temperature range of 110-190° C. for 2 to 180 min;
c) Cooling;
d) Optionally milling;
wherein the oil comprises the fatty acids C16:0 in the range of 1 to 10 wt% (based on weight of total fat) and C18:1 in the range of 75 to 90 wt% (based on weight of total fat) and C18:2 in the range of 0.5 to 10 wt% (based on weight of total fat).

In a preferred aspect the present invention pertains to a process for the production of a roasted plant material comprising 92 to 98 wt% (by weight of the total composition) plant material and 2 to 8 wt% (by weight of the total composition) oil, the process comprising the steps of:
a) Mixing the plant material and the oil;
b) Roasting the mix from step a) between a temperature range of 110-190° C. for 2 to 180 min;
c) Cooling;
d) Optionally milling;
wherein the oil comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

In a preferred aspect the present invention pertains to a process for the production of a roasted plant material comprising 92 to 98 wt% (by weight of the total composition) plant material and 2 to 8 wt% (by weight of the total composition) oil, the process comprising the steps of:
a) Mixing the plant material and the oil;
b) Roasting the mix from step a) between a temperature range of 110-190° C. for 2 to 180 min;
c) Cooling;
d) Optionally milling;
wherein the oil comprises the fatty acids C16:0 in the range of 1 to 10 wt% (based on weight of total fat) and C18:1 in the range of 75 to 90 wt% (based on weight of total fat) and C18:2 in the range of 0.5 to 10 wt% (based on weight of total fat).

In a first aspect the present invention pertains to a process for the production of a roasted plant material comprising plant material and oil, the process comprising the steps of:
a) Mixing the plant material and the oil;
b) Roasting the mix from step a) between a temperature range of 110-190° C. for 2 to 180 min;
c) Cooling;
d) Milling;
wherein the oil comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

In a first aspect the present invention pertains to a process for the production of a roasted plant material comprising plant material and oil, the process comprising the steps of:
a) Mixing the plant material and the oil;
b) Roasting the mix from step a) between a temperature range of 110-190° C. for 2 to 180 min;
c) Cooling;
d) Milling;
wherein the oil comprises the fatty acids C16:0 in the range of 1 to 10 wt% (based on weight of total fat) and C18:1 in the range of 75 to 90 wt% (based on weight of total fat) and C18:2 in the range of 0.5 to 10 wt% (based on weight of total fat).

In a preferred aspect the present invention pertains to a process for the production of a roasted plant material comprising 92 to 98 wt% (by weight of the total composition) plant material and 2 to 8 wt% (by weight of the total composition) oil, the process comprising the steps of:
a) Mixing the plant material and the oil;
b) Roasting the mix from step a) between a temperature range of 110-190° C. for 2 to 180 min;
c) Cooling;
d) Milling;
wherein the oil comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

In a preferred aspect the present invention pertains to a process for the production of a roasted plant material comprising 92 to 98 wt% (by weight of the total composition) plant material and 2 to 8 wt% (by weight of the total composition) oil, the process comprising the steps of:
a) Mixing the plant material and the oil;
b) Roasting the mix from step a) between a temperature range of 110-190° C. for 2 to 180 min;
c) Cooling;
d) Milling;
wherein the oil comprises the fatty acids C16:0 in the range of 1 to 10 wt% (based on weight of total fat) and C18:1 in the range of 75 to 90 wt% (based on weight of total fat) and C18:2 in the range of 0.5 to 10 wt% (based on weight of total fat).

In a second aspect the invention relates to a roasted plant material comprising plant material and oil, wherein the roasted plant material has an amount of oleic acid of at least 2 wt% (by weight of the total composition).

In a preferred aspect the invention relates to a roasted plant material comprising 92 to 98 wt% (by weight of the total composition) plant material and 2 to 8 wt% (by weight of the total composition) oil, wherein the roasted plant material has an amount of oleic acid of at least 2 wt% (by weight on the total composition).

In a preferred aspect the invention relates to a roasted plant material comprising 92 to 98 wt% (by weight of the total composition) plant material and 2 to 8 wt% (by weight of the total composition) oil, wherein the roasted plant material have an amount of oleic acid in the range of 2 to 7 wt% (by weight of the total composition).

In a preferred aspect of the invention, there is provided a product obtainable by the process of the invention. All combinations should be considered.

The term “plant material” according to this invention means at least one ingredient of onion, garlic, cumin seeds, coriander seeds, potatoes, carrots, eggplants/aubergines, zucchini/courgette, pumpkin, turnips, rutabagas/swedes, parsnips, cauliflower, asparagus, squash, peppers, yam and plantain or combination thereof, preferably onion, garlic, cumin seeds, coriander seeds or combination thereof. In an embodiment the term “plant material” according to this invention means at least one ingredient of dehydrated plant material. Dehydrated plant material is selected from the group consisting onion, garlic, cumin seeds, coriander seeds, potatoes, carrots, eggplants/aubergines, zucchini/courgette, pumpkin, turnips, rutabagas/swedes, parsnips, cauliflower, asparagus, squash, peppers, yam and plantain or combination thereof, preferably dehydrated onion flakes, dehydrated garlic flakes, cumin seeds, coriander seeds or combinations thereof. In an embodiment the roasted plant material comprises 90 to 98 wt% of plant material (by weight of the total composition), preferable 92 to 98 wt%, preferable 93 to 97 wt%, preferable 93 to 96 wt%, preferable 94 to 97 wt%, preferable 94 to 96 wt% (by weight of the total composition).

The term “oil” according to this invention comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat) is a high oleic sunflower oil. In an embodiment the oil comprises C16:0. C16:0 is palmitic acid. In a further embodiment C16:0 is in the range of 1 to 25 wt% (based on weight of total fat), preferably C16:0 is in the range of 1 to 20 wt% (based on weight of total fat), preferably C16:0 is in the range of 1 to 15 wt% (based on weight of total fat), preferably C16:0 is in the range of 1 to 10 wt% (based on weight of total fat), more preferably C16:0 is in the range of 2 to 7 wt% (based on weight of total fat). In an embodiment the oil comprises C18:1. C18:1 is oleic acid. In a further embodiment C18:1 is in the range of 60 to 90 wt% (based on weight of total fat), preferably C18:1 is in the range of 65 to 90 wt% (based on weight of total fat), preferably C18:1 is in the range of 70 to 90 wt% (based on weight of total fat), preferably C18:1 is in the range of 75 to 90 wt% (based on weight of total fat), more preferably C18:1 is in the range of 80 to 90 wt% (based on weight of total fat). In an embodiment the oil comprises C18:2. C18:2 is linoleic acid. In a further embodiment C18:2 is in the range of 0.1 to 20 wt% (based on weight of total fat), preferably C18:2 is in the range of 0.1 to 15 wt% (based on weight of total fat), preferably C18:2 is in the range of 0.1 to 10 wt% (based on weight of total fat), preferably C18:2 is in the range of 0.5 to 10 wt% (based on weight of total fat), more preferably C18:2 is in the range of 0.5 to 5 wt% (based on weight of total fat). In an embodiment the oil comprises C18:0. C18:0 is stearic acid. In a further embodiment C18:0 is in the range of 0.1 to 5 wt% (based on weight of total fat), preferably C18:0 is in the range of 0.1 to 3 wt% (based on weight of total fat), preferably C18:0 is in the range of 1 to 3 wt% (based on weight of total fat). In an embodiment the oil is absent of C16:1. C16:1 is palmitoleic acid. In a further embodiment C16:1 is absent or C16:1 is 0 wt% (based on weight of total fat). In an embodiment the oil of this invention has a melting point of -1 to +5° C. and relative density of 0.91. It is preferred that the oil is liquid at room temperature (20° C.) to avoid unnecessary heating during storage and transfer of oil into the process, higher storage temperature of oil would already lead to oxidation of oil. Standard commercial available sunflower oil (see comp. example 3) comprising the fatty acids C16:0 in the range of 5 to 8 wt% (based on weight of total fat) and C18:1 in the range of 14 to 40 wt% (based on weight of total fat) and C18:2 in the range of 48 to 74 wt% (based on weight of total fat). Standard commercial available palm oil (see comp. example 2) comprising the fatty acids C16:0 in the range of 39 to 47 wt% (based on weight of total fat) and C18:1 in the range of 36 to 44 wt% (based on weight of total fat) and C18:2 in the range of 9 to 12 wt% (based on weight of total fat). In an embodiment the standard palm oil has a slip melting point between 30 to 50° C. and is solid at room temperature (20° C.)

In an embodiment the roasted plant material comprise 2 to 10 wt% of oil (by weight of the total composition), preferable 2 to 8 wt%, preferable 3 to 7 wt%, preferable 3 to 6 wt%, preferable 4 to 7 wt%, preferable 4 to 6 wt% (by weight of the total composition). In case the amount of oil is higher than 10 wt% the roasted plant material is perceived as too oily/fatty.

Roasting is a process wherein moisture from plant material is removed to a desired level and raw taste is eliminated and characteristic roasted/fried flavor is generated in the end product. The roasting with oil is done between a temperature range of 110-190° C. for 1 to 180 min, preferably between a temperature range of 120 to 180° C. for 2 to 40 min, preferably between a temperature range of 120 to 170° C. for 2 to 40 min, preferably between a temperature range of 130 to 170° C. for 2 to 40 min, preferably between a temperature range of 130 to 160° C. for 3 to 30 min.

After roasting the final moisture in the product is between 1 to 7%, preferably between 2 to 5 wt% (by weight of the total composition). The final product has a water activity < 0.3. The plant material before roasting has a moisture content between 6 to 15 wt%, preferably 6 to 10 wt%. The final product after roasting has a moisture content between 2 to 5 wt%.

Cooling means that the temperature of the roasted plant material is reduced. It is desirable to have the roasted plant material temperature the same as or close to room temperature before optionally milling and afterwards wrapping, preferably between 20 to 30° C., more preferably between 20 to 25° C. Otherwise, there may be condensation of water vapor in the packet of plant material, which may lead to mould growth. A side from condensates, hot roasted plant material also cause expansion of air within the pack, subsequently causing difficulty in secondary packaging.

Milling according to this invention is a process that breaks solid materials into smaller pieces by grinding, crushing, or cutting. Milling can be carried out by any commonly known milling techniques such as roll mill, hammer mill, chopper mill, ball mill, SAG mil, rod mil or combinations thereof.

The particle size Dv50 is used in the conventional sense as the median of the particle size distribution. Median values are defined as the value where half of the population reside above this point, and half resides below this point. The Dv50 is the size in micrometer that splits the volume distribution with half above and half below this diameter. The particle size distribution may be measured by laser light scattering, microscopy or microscopy combined with image analysis. For example, the particle size distribution may be measured by laser light scattering. Since the primary result from laser diffraction is a volume distribution, the Dv50 cited is the volume median.

In an embodiment the particle size Dv50 of the starting material before roasting is between 0.8 to 15 mm, preferably 0.8 to 10 mm. After milling the final product has a particle size of Dv50 below 600 µm, preferably Dv50 between 50 to 600 µm, preferably between 100 to 600 µm, preferably between 100 to 500 µm, preferably between 200 to 600 µm, preferably between 200 to 500 µm.

Those skilled in the art will understand that they can freely combine all features of the present invention disclosed herein. In particular, features described for different embodiments of the present invention may be combined. Where known equivalents exist to specific features, such equivalents are incorporated as if specifically referred to in this specification.

### EXAMPLES

### Example 1: Process

Dehydrated single whole plant material or a mix of whole plant materials are blended (mixed) with oil in a ribbon blender at a low speed for required time. The blend is then fed to a pre heated roaster for roasting. The plant material is roasted with low bed thickness at specified temperature for a specified time. In the initial phase moisture is removed followed by generation of new compounds that contributes to roasted/fried flavor profile. The roasted plant material is then cool down at ambient temperature. The roasted plant material is then milled by a hammer mill to obtain desired particle size for use in culinary applications. The milled plant material are then packed. Below table shows details of all the process steps with the process parameters:

| | | |
|---|---|---|
| Process Steps | Process Parameters | Moisture |
| Mixing with oil | Low Speed: 50 Hz, 10 minutes for uniform blending | 6-10% |
| Roasting | Final Product temperature - 140° C. Roasting time - 15 minutes Bed Thickness - 5 to 10 cm | 2-5% |
| Cooling | Ambient temperature | |
| Milling | Sieve size 1 mm | |

### Water Activity Measurement

Water activity is measured with AquaLab instruments 4TE and 4TEV connected to PC with Aqualink 4.0 software . Measurement is carried out at 25.0 ± 0.5° C. according to validated on the official AOAC method 978.18

### Peroxide Value (PV) Measurement

Peroxide Value (PV) in the samples is analyzed as per internal LI based on AOCS method Cd 8b-90 and can be applied to animal and vegetable oils and fats. It is the quantity of all the substances in terms of mill equivalents of peroxides per 1000 grams of sample that oxidize potassium iodide under the operating conditions. These substances are generally assumed to be peroxides or other similar products of fat oxidation.

### Total Polar Material (TPM) Measurement

TPM is measured using rapid method with hand-held probe (Testo 270) which is based on principal of capacitive measurement. This is validated with standard method, ISO 8420. TPM gives the value of total polar compounds in oil generated during frying process.

### Free Fatty Acid Measurement

Free Fatty Acids (FFA) in the samples was analysed as per LI 03.516-3. This method corresponds to the International standard method ISO 660:2008 - Animal and vegetable fats and oils-Determination of acid value and acidity with minor modifications. It is applicable to edible oils and fats, and the extracted fat. FFA’s are generally formed due to the presence of moisture in the foods exposed to oil. The present method determines the amount of these FFA’s formed by titration against a base, and generally expressed as percent oleic acid, unless otherwise stated.

### Examples 2-5

Comparison example 2 is done according to example 1, but as dry roasting without using any oil. Comparison examples 3 to 4 and example 5 are prepared according to example 1. Comparison example 3 use palm oil and comparison example 4 use standard sunflower oil for roasting.

| | | | | |
|---|---|---|---|---|
| | Comp. Ex 2 | Comp. Ex 3 | Comp. Ex 4 | Ex. 5 |
| Onion (dehydrated) | 100% | 94% | 94% | 94% |
| Oil used for roasting | - | Palm oil | Sunflower oil | HOSO |
| Amount of oil | 0% | 6% | 6% | 6% |
| Moisture in final product | 3% | 3% | 3% | 3% |
| Water Activity in final product | 0.3 | 0.3 | 0.3 | 0.3 |
| C16:0 | - | 43 | 6 | 4 |
| C18:0 | - | 4 | 3 | 3 |
| C18:1 | - | 39 | 28 | 83 |
| C18:2 | - | 10 | 59 | 8 |
| Free Fatty Acid- Fresh Oil | - | 0.07 | 0.07 | 0.03 |
| TPM- Fresh Oil | - | 8.0% | 8.5% | 2.5% |
| Glycidyl fatty acid esters (ppm-Fresh Oil) | - | 0.94 | 0.33 | 0.40 |
| Shelf-life | 9 months | 9 months | Max. 6 months | 9 months |
| Sensory data - Overall intensity, roasted and fried notes (as compared to dry roasting) | Slight difference vs unroasted onion. No fried note. No caramelized note. | Slight difference vs dry roasted onion. More intense, more roasted, caramelized and fried note. | Clear difference vs dry roasted onion More intense, more roasted, caramelized and fried note. | Clear difference vs dry roasted onion More overall intense, more roasted, caramelized and fried note. |
| *Sensory data - Off note evaluation by panel after 9 months | No off note, but also no caramelized, fried notes and less intense taste compared to oil roasting | Less than 1 on scale of 5 | More than 4 on scale of 5 (probably due to lipid oxidation compounds) | Less than 1 on scale of 5 |

*0- No off note, 5- Very high off notes (Flavor and Aroma); 20 panellists tested.

It is shown that by using an oil of the invention for roasting onions, the lowest values for free acids (FFA), total polar material (TPM) and glycidyl fatty esters are achieved. In addition within example 5 it is shown that a shelf-stable product can be obtained having good sensory data and a lower amount of TPM.

### Examples 6 to 9

Comparison example 6 is done according to example 1, but as dry roasting without using any oil. Comparison examples 7 to 8 and example 9 are prepared according to example 1. Comparison example 7 use palm oil and comparison example 8 use standard sunflower oil for roasting.

| | | | | |
|---|---|---|---|---|
| | Comp. Ex 6 | Comp. Ex 7 | Comp. Ex 8 | Ex. 9 |
| garlic (dehydrated) | 100% | 96% | 96% | 96% |
| Oil used for roasting | | Palm oil | Sunflower oil | HOSO |
| Amount of oil | 0% | 4% | 4% | 4% |
| Moisture in final product | 3% | 3% | 3% | 3% |
| Water Activity in final product | 0.3 | 0.3 | 0.3 | 0.3 |
| C16:0 | | 43 | 6 | 4 |
| C18:0 | | 4 | 3 | 3 |
| C18:1 | | 39 | 28 | 83 |
| C18:2 | | 10 | 59 | 8 |
| Free Fatty Acid- Fresh Oil | | 0.07 | 0.07 | 0.03 |
| TPM- Fresh Oil | | 8.0% | 8.5% | 2.5% |
| Glycidyl fatty acid esters (ppm-Fresh Oil) | | 0.94 | 0.33 | 0.40 |
| Shelf-life | 9 months | 9 months | Max. 6 months | 9 months |
| Sensory data - Overall intensity, roasted and fried notes (as compared to dry roasting) | Slight difference vs unroasted garlic. No fried note. No caramelized note. | Slight difference vs dry roasted garlic. More intense, more roasted, caramelized and fried note. | Clear difference vs dry roasted garlic More intense, more roasted, caramelized and fried note. | Clear difference vs dry roasted garlic More overall intense, more roasted, caramelized and fried note. |
| *Sensory data - Off note evaluation by panel after 9 months | No off note, but also no caramelized, fried notes and less intense taste compared to oil roasting | Less than 1 on scale of 5 | More than 3.5 on scale of 5 (probably due to lipid oxidation compounds) | Less than 1 on scale of 5 |

*0- No off note, 5- Very high off notes (Flavor and Aroma); 20 panellists tested.

It is shown that by using an oil of the invention for roasting garlic, the lowest values for free acids (FFA), total polar material (TPM) and glycidyl fatty esters are achieved. In addition, within example 9 it is shown that a shelf-stable product can be obtained having good sensory data and a lower amount of TPM.

### Examples 10 to 13

Comparison example 10 is done according to example 1, but as dry roasting without using any oil. Comparison examples 11 to 12 and example 13 are prepared according to example 1. Comparison example 11 use palm oil and comparison example 12 use standard sunflower oil for roasting.

| | | | | |
|---|---|---|---|---|
| | Comp. Ex 10 | Comp. Ex 11 | Comp. Ex 12 | Ex. 13 |
| Coriander seeds | 100% | 95% | 95% | 95% |
| Oil used for roasting | | Palm oil | Sunflower oil | HOSO |
| Amount of oil | 0% | 5% | 5% | 5% |
| Moisture in final product | 3% | 3% | 3% | 3% |
| Water Activity in final product | 0.3 | 0.3 | 0.3 | 0.3 |
| C16:0 | | 43 | 6 | 4 |
| C18:0 | | 4 | 3 | 3 |
| C18:1 | | 39 | 28 | 83 |
| C18:2 | | 10 | 59 | 8 |
| Free Fatty Acid- Fresh Oil | | 0.07 | 0.07 | 0.03 |
| TPM- Fresh Oil | | 8.0% | 8.5% | 2.5% |
| Glycidyl fatty acid esters (ppm-Fresh Oil) | | 0.94 | 0.33 | 0.40 |
| Shelf-life | 9 months | 9 months | Max. 6 months | 9 months |
| Sensory data - Overall intensity, roasted and fried notes (as compared to dry roasting) | Slight difference vs unroasted coriander seeds. No fried note. | Slight difference vs dry roasted coriander seeds. More intense and fried note. | Clear difference vs dry roasted coriander seeds More intense and fried note. | Clear difference vs dry roasted coriander seeds More intense and fried note. |
| *Sensory data- Off note evaluation by panel after 9 months | No off note, but also no fried notes and less intense taste compared to oil roasting | Less than 1 on scale of 5 | More than 3.5 on scale of 5 (probably due to lipid oxidation compounds) | Less than 1 on scale of 5 |

*0- No off note, 5- Very high off notes (Flavor and Aroma); 20 panellists tested.

It is shown that by using an oil of the invention for roasting coriander seeds, the lowest values for free acids (FFA), total polar material (TPM) and glycidyl fatty esters are achieved. In addition, within example 13 it is shown that a shelf-stable product can be obtained having good sensory data and a lower amount of TPM.

1. A process for the production of a roasted plant material comprising plant material and oil, the process comprising the steps of:
a) Mixing the plant material and the oil;
b) Roasting the mix from step a) between a temperature range of 110-190° C. for 2 to 180 min;
c) Cooling; and
wherein the oil comprises the fatty acids C16:0 in the range of 1 to 25 wt% (based on weight of total fat) and C18:1 in the range of 60 to 90 wt% (based on weight of total fat) and C18:2 in the range of 0.1 to 20 wt% (based on weight of total fat).

2. A process for the production of a roasted plant material as claimed in claim 1, wherein the plant material is selected from the group consisting of onion, garlic, cumin seeds, coriander seeds, potatoes, carrots, eggplants/aubergines, zucchini/courgette, pumpkin, turnips, rutabagas/swedes, parsnips, cauliflower, asparagus, squash, peppers, yam and plantain and combinations thereof .

3. A process for the production of a roasted plant material in claim 1, wherein the weight of the plant material is in the range of 90 to 98 wt% (by weight of the total composition).

4. A process for the production of a roasted plant material in claim 1, wherein the plant material in step a) is a dehydrated plant material.

5. A process for the production of a roasted plant material in claim 1, wherein the plant material in step a) has a particle size Dv50 between 0.8 to 15 mm.

6. A process for the production of a roasted plant material in claim 1, wherein the plant material in step a) has a water activity between 0.4 -0.6.

7. A process for the production of a roasted plant material in claim 1, wherein the weight of the oil is in the range of 2 to 10 wt% (by weight of the total composition).

8. A process for the production of a roasted plant material in claim 1, wherein the oil is liquid at 20° C.

9. A process for the production of a roasted plant material in claim 1, wherein the roasted plant material in step c) has a water activity between 0.1-0.3.

10. A process for the production of a roasted plant material as claimed in claim 1, wherein the oil comprises the fatty acids C16:0 in the range of 1 to 15 wt% (based on weight of total fat), C18: 1 in the range of 75 to 90 wt% (based on weight of total fat) and C18:2 in the range of 0.5 to 10 wt% (based on weight of total fat).

11. A process for the production of a roasted plant material as claimed in claim 1, wherein the cooling is done to a temperature between 15 to 40° C.

12. A process for the production of a roasted plant material as claimed in claim 1, wherein the roasted plant material has a particle size Dv50 between 50 to 600 µm after milling.

13. A dehydrated roasted plant material comprising 90 to 98 wt% (by weight of the total composition) of a plant material and 2 to 10 wt% (by weight of the total composition) of oil, and wherein the dehydrated roasted plant has an amount of oleic acid in the range of 2 to 7_wt% (by weight of the total composition).

14. (canceled)
